(19) United States
(12) Patent Application Publication
(10) Pub. No.: US 2003/0106439 A1
(43) Pub. Date: Jun. 12, 2003

(54) Press for canned comestibles

(76) Inventor: Larry W. Yarberry, Virginia Beach, VA (US)

Correspondence Address: Richard C. Litman, LITMAN LAW OFFICES, LTD., P.O. Box 15035, Arlington, VA, 22215, US

(21) Appl. No.: 10/003,251

(22) Filed: Dec. 6, 2001

(51) Int. Cl. B30B 9/06

(52) U.S. Cl. 100/110; 100/234

(57) ABSTRACT

An efficient, clean, safe, easy-to use utensil that is utilized to drain liquids from canned comestibles such as meat, tuna, salmon, chicken, etc. The utensil includes two light-weight levers or arms which are connected together at one end for pivoted movement relative to each other. One arm is provided with a section which is adapted to support an opened can of comestibles therein. The other arm is equipped with a circular section adapted to contact the comestibles in the opened can and press the liquid therefrom.

### BACKGROUND OF THE INVENTION

1. Field of the Invention

The present invention generally relates to kitchen utensils. More specifically, the present invention is drawn to a press for draining liquid from canned foods.

2. Description of the Related Art

Foods such as meat, salmon and tuna are most often canned with a high content of water and/or oil. The usual practice is to separate the water and/or oil from the canned food before use. In a common scenario, the can is opened at one end and inverted over a sink drain while still retaining (by hand) the can's lid in place. Aside from the messiness involved, the serrated edges of the lid may easily cut the user's hand. An easy-to-use, efficient tool that would alleviate the deficiencies of the above draining process would certainly be a welcomed addition to the art.

U.S. Pat. No. 3,995,544 (Farley) discloses a strainer utensil comprising a cup-shaped member having a perforated end wall. The member is adapted to be inserted in a standard sized can and rotated into an inverted position to permit drainage of liquid from the can. It should be noted that the hands of the user are subject to be contacted by the drained liquid.

U.S. Pat. No. Des. 342,649 (Miller et al.), U.S. Pat. No. 5,272,969 (McDonald), U.S. Pat. No. 6,227,104 B1 (Watkins, Jr.) and U.S. Pat. No. 6,234,074 B1 (Mangum) disclose press devices having pivoted arms. However, none of the patents show stepped base structure for receiving cans of varying diameters or structure for encompassing the walls of a can during the draining process.

U.S. Pat. No. 5,363,759 (D'Ambrosio) shows a guillotine-type press having a stepped base. There is no wall to encompass and stabilize the can. Also, the drained liquids would contact the hand of the user.

U.S. Pat. No. 6,196,122 B1 (Lai) is drawn to a fruit juicer. The patentee does not contemplate draining liquids from canned food.

U.S. Pat. No. Des. 366,189 (Bidlack) discloses an ornamental design for a draining press. The device does not appear to have a stepped base or can-encompassing walls.

None of the above inventions and patents, taken either singularly or in combination, is seen to disclose a press for canned comestibles as will subsequently be described and claimed in the instant invention.

### SUMMARY OF THE INVENTION

The instant invention is an efficient, clean, safe, easy-to use utensil that is utilized to drain liquids from canned comestibles such as meat, tuna, salmon, chicken, etc. The utensil comprises two light-weight levers or arms which are connected together at one end for pivoted movement relative to each other. One arm is provided with a section, which section is adapted to securely support an opened can of comestibles therein. The other arm is equipped with a circular section adapted to contact the comestibles in the opened can and press the liquid therefrom.

Use of the utensil will prevent the drained liquid from contacting the hands of the user. Further, the user will not be required to contact the sharp edges of the opened can, thereby preventing cuts to the hand.

Accordingly, it is a principal object of the invention to provide a utensil for draining liquids from canned comestibles.

It is another object of the invention to provide a utensil for draining liquids from canned comestibles, which utensil will securely support a can of comestibles thereon.

It is a further object of the invention to provide a utensil for draining liquids from canned comestibles, which utensil is adapted to support cans of varying diameters.

Still another object of the invention is to provide a utensil for draining liquids from canned comestibles, which utensil is easy to use.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a press for canned comestibles according to the present invention.

FIG. 2 is a side view of a press for canned comestibles according to the present invention.

FIG. 3 is a perspective view of a press for canned comestibles according to the present invention.

Similar reference characters denote corresponding features consistently throughout the attached drawings.

### DETAILED DESCRIPTION OF THE PREFERRED EMBODIMENT

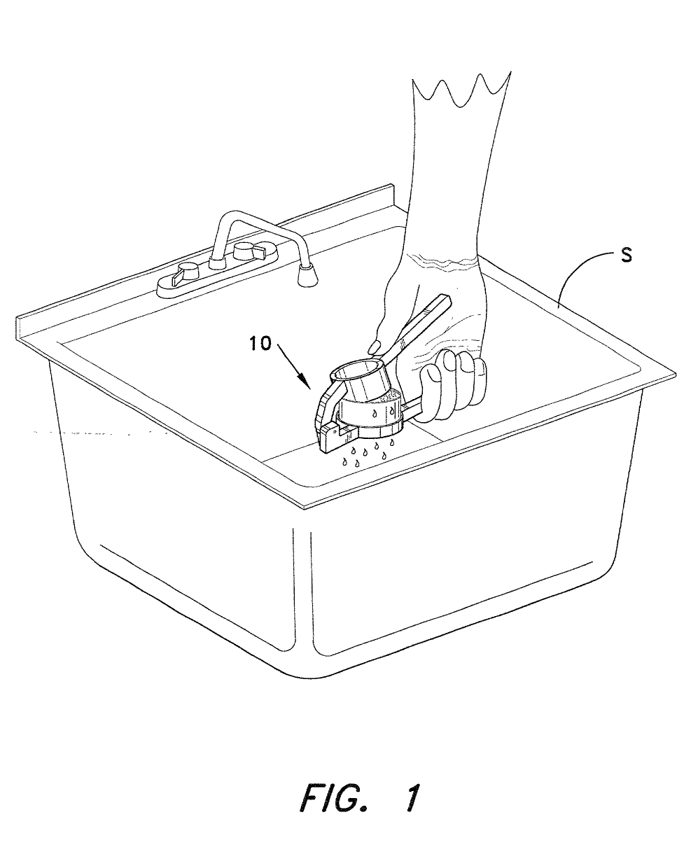

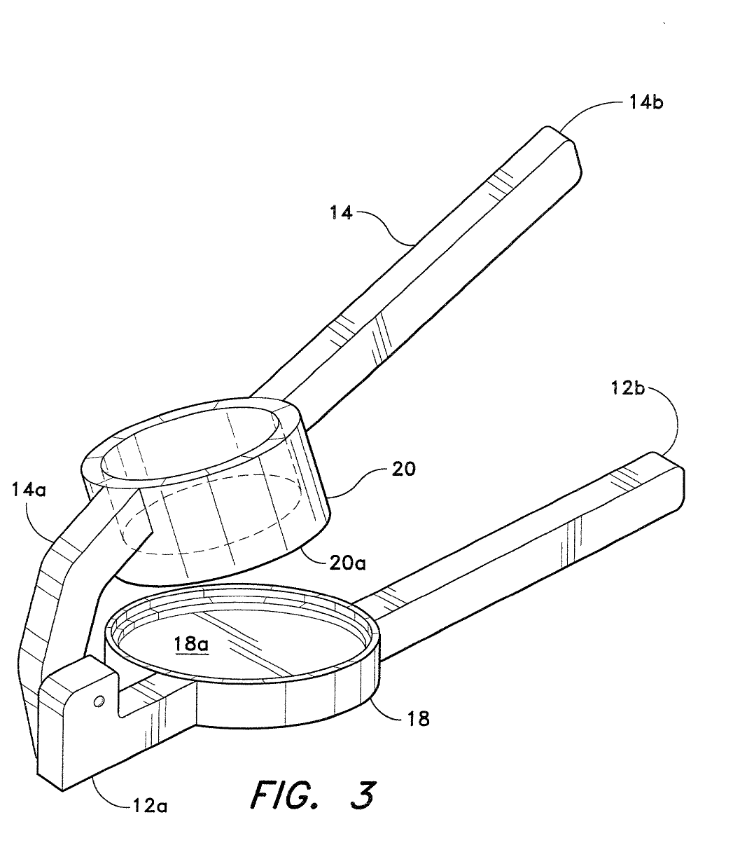

As illustrated in FIGS. 1-3, the utensil of the present invention is generally indicated at 10. Utensil 10 is preferably fabricated from aluminum, however other suitable metal or plastic materials may be utilized. Utensil 10 comprises a pair of elongate arms 12 and 14. Arms 12, 14 are provided with front ends 12a, 14a, which front ends are pivotally connected via a pivot pin 16. At their rear ends arms 12, 14 terminate in handle portions 12b, 14b.

A member 18 is incorporated as a part of lower arm 12 and is positioned adjacent the front end thereof. Member 18 is designed with an upstanding continuous wall of circular configuration having an open top and a solid bottom wall 18a. Bottom wall 18a is provided with stepped portions so as to securely accommodate comestible cans of varying diameters. As shown, member 18 will accommodate comestible cans of at least two standard diametrical sizes. It is obvious that more steps may be included, if desired, to accommodate small, medium and large standard cans.

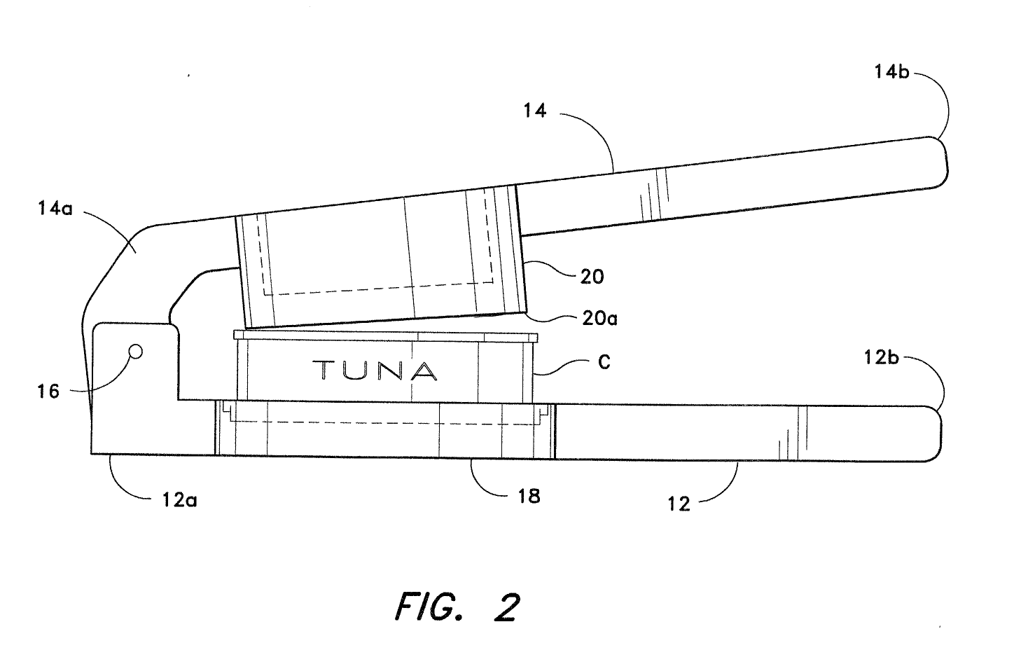

A member 20 is incorporated as a part of upper arm 14 and is positioned adjacent the front end thereof. Member 20 is also designed with an upstanding, continuous circular wall having an open top and a solid bottom wall 20a. Member 20 is of a diametrical size to allow bottom wall 20a to fit into the opening of a standard sized can C when arms 12, 14 are pivoted toward each other (FIG. 2).

To use the utensil, a can of comestibles C is opened in a conventional manner and the lid may be used to aid in draining or discarded. The can C is then securely positioned in member 18 and the utensil is held over a sink S or the like (FIG. 1). Arms 12, 14 are pivoted toward each other to allow wall 20a to contact and press the comestibles thereby causing liquids to drain from the can. The utensil is then inverted to complete the draining process.

It is to be understood that the present invention is not limited to the sole embodiment described above, but encompasses any and all embodiments within the scope of the following claims.

I claim:

1. A liquid press for canned comestibles comprising:
an upper elongate arm, said upper elongate arm having a first end and a second end;
a lower elongate arm, said lower elongate arm having a first end and a second end;
a pin pivotally connecting the first end of said upper elongate arm to the first end of said lower elongate arm;
a first member disposed on said lower elongate arm, said first member adapted to support an opened can containing comestibles;
said first member having an upstanding continuous wall and an open top;
a solid wall defining the bottom of said first member; and
means on said upper elongate arm for pressing liquids from the opened can of comestibles.

2. A liquid press for canned comestibles as recited in claim 1, wherein said first member is disposed adjacent the first end of said lower elongate arm.

3. A liquid press for canned comestibles as recited in claim 2, including at least one stepped portion formed on said solid wall.

4. A liquid press for canned comestibles as recited in claim 3, wherein said upstanding continuous wall is of circular configuration.

5. A liquid press for canned comestibles as recited in claim 4, wherein said means on said upper elongate arm includes a second member having an upstanding continuous wall, an open top and a solid bottom wall.

6. A liquid press for canned comestibles as recited in claim 5, wherein said second member is disposed adjacent the first end of said upper elongate arm.

7. A liquid press for canned comestibles as recited in claim 6, wherein said upstanding wall of said second member is of circular configuration.

8. A liquid press for canned comestibles as recited in claim 7, wherein said upper arm, said lower arm, said first member and said second member are fabricated from aluminum.

9. A liquid press for canned comestibles comprising:
an upper elongate arm, said upper elongate arm having a first end and a second end, said second end defining a handle;
a lower elongate arm, said lower elongate arm having a first end and a second end, said second end of said lower elongate arm defining a handle;
a pin pivotally connecting the first end of said upper elongate arm to the first end of said lower elongate arm;
a first member disposed on said lower elongate arm, said first member adapted to support an opened can containing comestibles;
said first member having an upstanding continuous wall and an open top;
a solid wall defining the bottom of said member; and
a second member disposed on said upper elongate arm for pressing liquids from the opened can of comestibles.

10. A liquid press for canned comestibles as recited in claim 9, wherein said first member is disposed adjacent the first end of said lower elongate arm.

11. A liquid press for canned comestibles as recited in claim 10, including at least one stepped portion formed on said solid wall.

12. A liquid press for canned comestibles as recited in claim 11, wherein said upstanding continuous wall is of circular configuration.

13. A liquid press for canned comestibles as recited in claim 12, wherein said second member on said upper elongate arm includes an upstanding continuous wall, an open top and a solid bottom wall.

14. A liquid press for canned comestibles as recited in claim 13, wherein said second member is disposed adjacent the first end of said upper elongate arm.

15. A liquid press for canned comestibles as recited in claim 14, wherein said upstanding wall of said second member is of circular configuration.

16. A liquid press for canned comestibles as recited in claim 15, wherein said upper arm, said lower arm, said first member and said second member are fabricated from aluminum.

17. A liquid press for canned comestibles as recited in claim 15, wherein said upper arm, said lower arm, said first member and! said second member are fabricated from plastic.
